(19) United States
(12) Patent Application Publication
(10) Pub. No.: US 2003/0214512 A1
(43) Pub. Date: Nov. 20, 2003

(54) Hardware method for sub-pixel anti-aliasing of text on an LCD display

(76) Inventor: Brett Anthony Cheng, Vancouver (CA)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/145,242

(22) Filed: May 14, 2002

(51) Int. Cl. G09G 5/00

(52) U.S. Cl. 345/611

(57) ABSTRACT

A graphics controller of the present invention is designed for use with or combined with a system that includes a display device having a plurality of pixels, each pixel being divided into a plurality of sub-pixels. A plurality of sub-pixel addresses may be stored in memory, each of the plurality of sub-pixels having an associated sub-pixel address. A processor has an anti-aliasing graphics control mode in which each of the plurality of sub-pixels may be addressed by its associated sub-pixel address. In one alternative preferred dual-mode embodiment, a plurality of pixel addresses may also be stored in memory, each of the plurality of pixels having an associated pixel address. In this dual-mode embodiment the processor also has a normal graphics control mode in which each of the plurality of pixels may be addressed by its associated pixel address. Control signals provided to the processor actuate the anti-aliasing and/or normal graphics control mode. The present invention also includes methods for using the graphics controller.

### BACKGROUND OF THE INVENTION

Field of the Invention

The present invention is directed to a hardware method for sub-pixel anti-aliasing that allows the specific addressing of sub-pixels, the addressing of either whole pixels or individual sub-pixels, or the addressing of both whole pixels and individual sub-pixels. More specifically the present invention is directed to a hardware method for sub-pixel anti-aliasing of text on an LCD display.

A Liquid Crystal Display (LCD) has an array of pixels (e.g., 800 rows×600 columns) that are selectively illuminated to display an image on the LCD. As shown in FIG. 1, in a color LCD, each pixel 20 is comprised of three sub-pixels 22 in one of the three primary colors: red (R), blue (b), or green (G). The sub-pixels 22 are situated side-by-side. A pixel 20 of the desired color is created by varying the intensity of the light emitted by each of the three primary color sub-pixels. Visually, the primary color sub-components mix so that the pixel is perceived as a single color. Turning all the sub-pixels 22 “on” (to maximum intensity) is perceived as “white” and turning all the sub-pixels 22 “off” (to minimum or no intensity) is perceived as “black.” By varying the respective intensities of the sub-pixels 22, a full spectrum of colors may be produced.

An application program determines the particular image to display on an LCD. Typically, the application program specifies an image in terms of primitives (such as lines and polygons) to be displayed. In the raster graphic systems used with LCDs, the primitives are scan-converted into component pixels and stored as a pixmap (pixel map) in memory commonly referred to as a frame buffer. The pixmap is an array of pixel values that map one-for-one to pixels on the screen. An image is then displayed on the LCD screen through the operation of scan out logic which reads the contents of the frame buffer and writes the values read to the individual pixels 20 of the display.

Aliasing is a problem in the raster graphic systems used with LCDs. Aliasing refers to the jagged or stair-stepped appearance of a curved or diagonal line. As shown in FIG. 2, aliasing results from representing a continuous, sharp-edged line with discrete pixels set to either maximum or zero intensity.

Anti-aliasing refers to techniques (first developed in the 1970s) for making the appearance of Jagged lines appear smooth. Early anti-aliasing techniques use pixels 20a of gray or color gradations alone or in combination with solid pixels 20b. The expectation for this technique was that a user's eyes will average the pixels 20a, 20b to see the line that the programmer is trying to show. Generally, as shown in FIG. 3, the gradated pixels 20a are used along the edges of the image to smooth out its appearance. In practice, this often results in a blurred image.

Using sub-pixels 22 to render smoother images is also known. As shown in FIG. 4, when sub-pixels 22 are used to render the image the resulting image is three times more horizontally accurate than the same image produced with whole pixels 20. Because the sub-pixels 22 are smaller, the jagged or stair-stepped appearance is reduced. This process is known as “borrowing” sub-pixels from adjacent whole pixels 20. Further, with colored pixels, because the borrowed sub-pixels are always adjacent their complementary color pixels, the user's eyes see white which further enhances the effect.

Increasing display resolution has been suggested as a method for solving aliasing problems. Typical displays have resolutions of 72 or 96 dots (pixels) per inch (dpi). Although simply increasing display resolutions (e.g. greater than 150 dpi) would solve the problem of jagged or stair-stepped appearance, existing software would have other problems at the higher resolutions. For example, the graphical user interface (GUI) elements of current operating systems (e.g. Windows, Macintosh, and UNIX desktops) would become too small to be usable. Applications would fail because GUI elements (e.g. buttons, labels, sliders, and handles) would become too small. Because most text sizes assume that one pixel is approximately equal to one point (72 dpi), text at higher resolutions would be unreadable. Graphics that are not vector based (e.g. raster graphics such as GIFs and JPEG files) would also be shrunk. A solution that does not take into consideration existing software would not be a satisfactory solution.

U.S. Pat. No. 6,239,783 to Hill et al. (the “'783 Hill reference”) is directed to weighted mapping of image data samples to pixel sub-components (sub-pixels) on a display device. U.S. Pat. No. 6,188,385 to Hill et al. (the “'385 Hill reference”) is directed to a method and apparatus for displaying images such as text. The '783 Hill reference and the '385 Hill reference are discussed related and are referred to jointly as the “Hill references.” The Hill references state that LCD display devices utilize multiple distinctly addressable sub-pixels and discuss treating each sub-pixel as a separate independent luminous intensity source as opposed to treating the set of sub-pixels of a whole pixel as a single luminous intensity unit. But the Hill reference uses software to address the sub-pixel as part of the whole pixel. For example, the '783 Hill reference sets forth that weighting may be applied during the scan conversion operation to determine whether a particular sub-pixel should be turned on or off. In one example, based on the weighting operation, the “blue pixel sub-component” is turned “on” in column 1, row 4, the “red pixel sub-component” is turned “on” in column 1, row 5 and the remaining pixel sub-components of column 1 are turned “off.” Although it is unclear how this is implemented, there is no mention of specific hardware.

As shown in FIG. 5, using a simplified version of conventional sub-pixel anti-aliasing scheme, drawing a line on a color LCD would include setting the whole pixels to various colors. In the shown embodiment, the following colors would be applied to the respective pixel address:

| Pixel: 00000000 | 00000001 | 00000001 |
|---|---|---|
| Color: blue | red + green | black |
| Pixel: 00010000 | 00010001 | 00010001 |
| Color: black | red + green + blue | black |
| Pixel: 00100000 | 00100001 | 00100001 |
| Color: black | green + blue | red |

Special problems exist with the use of color displays. For example, “color fringing” occurs when there is a local color imbalance. One exemplary method of correcting color fringing is to spread each sub-pixel's “energy” across it and its two neighboring sub-pixels. Another exemplary problem involves spatial displacement.

Anti-aliasing techniques also cause problems with system speed. To that end, various improvements have been suggested. For example, the anti-aliasing technique is described in U.S. Pat. No. 5,831,627 to Cohen (the “Cohen reference”). The Cohen reference is directed to a system for providing improved graphics generation performance such as real-time anti-aliasing using memory lookup. Each pixel of an image to be displayed is associated with a foreground color, a background color, and a transparency factor. These attributes are used to generate an index into a table of mixed colors that is stored in memory. The table only needs to be created once for each time the graphics application is executed. The use of the table eliminates the complicated processing intensive computations.

### BRIEF SUMMARY OF THE INVENTION

The present invention is directed to a hardware solution that solves the problem of jagged or stair-stepped appearance, but takes into consideration existing software. Specifically, the present invention is a hardware method and system for sub-pixel anti-aliasing. The present invention allows the specific addressing of sub-pixels. One alternative embodiment allows the addressing of either whole pixels or individual sub-pixels. Another alternative embodiment allows the addressing of both whole pixels and individual sub-pixels.

The present invention is directed to a graphics controller for use with an external system that includes a display device having a plurality of pixels, each pixel being divided into a plurality of sub-pixels. Alternatively, the present invention may be directed to a complete system that includes a graphics controller.

The graphics controller preferably includes a processor suitable for receiving control signals and for sending instructions to the display device. A plurality of sub-pixel addresses may be stored in memory, each of the plurality of sub-pixels having an associated sub-pixel address. The processor has an anti-aliasing graphics control mode in which each of the plurality of sub-pixels may be addressed by its associated sub-pixel address. In one alternative preferred embodiment, a plurality of pixel addresses may also be stored in memory, each of the plurality of pixels having an associated pixel address. In this alternative preferred embodiment the processor also has a normal graphics control mode in which each of the plurality of pixels may be addressed by its associated pixel address. Control signals provided to the processor actuate the anti-aliasing and/or normal graphics control mode.

The present invention also includes methods for using the graphics controller set forth above. Exemplary steps may include: receiving a graphic display signal using a graphics control processor; determining an address of an anti-aliasing graphics control memory from the graphic display signal; determining a luminance value from the graphic display signal; storing the luminance value at the address of the anti-aliasing graphics control memory; and illuminating a sub-pixel associated with the address based on the luminance value. These steps may be repeated for each sub-pixel on the display. If both the anti-aliasing and normal graphics control modes are available a method for using the graphics controller may include the following exemplary steps: receiving a graphic display signal using a graphics control processor; determining if there is a mode selection signal; processing the graphic display signal components in a normal mode if the mode selection signal is absent; determining if the mode selection signal is an anti-aliasing selection signal; processing the graphic display signal components in an anti-aliasing mode if the mode selection signal is an anti-aliasing selection signal; determining if the mode selection signal is a combined selection signal; and processing the graphic display signal components in a combined mode if the mode selection signal is a combined selection signal.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a color LCD pixel having three sub-pixels: red (R), blue (b), and green (G).

FIG. 2 illustrates aliasing results from a continuous, sharp-edged line with discrete pixels set to either maximum or zero intensity.

FIG. 3 illustrates an image having gradated pixels along its edges to smooth out its appearance.

FIG. 4 illustrates an image in which sub-pixels are used to render the image and thereby produce times more horizontal accuracy.

FIG. 5 illustrates an image in which whole pixels are set to various colors so that the colored sub-pixels are used to render the image.

FIG. 6 is a simplified block diagram of one preferred system of the present invention having physically separate anti-aliasing and normal graphic controllers.

FIG. 7 is a simplified block diagram of another preferred system of the present invention having a physically combined anti-aliasing/normal graphic controller.

FIG. 8 illustrates two rows and two columns of a display, each pixel having three sub-pixels with exemplary addresses.

FIG. 9 is a flow chart of an exemplary method for processing graphics in an anti-aliasing mode.

FIG. 10 is a flow chart showing an exemplary decision process for processing graphics in an anti-aliasing mode, a normal mode, or a combined mode.

FIG. 11 is a flow chart of an exemplary method for processing graphics in a combined mode including both an anti-aliasing mode and a normal mode.

### DETAILED DESCRIPTION OF THE INVENTION

Known graphic system architecture presently addresses only whole pixels 20, but not the individual sub-pixels 22. The present invention contemplates the use of a hardware system 30 that allows the specific addressing of sub-pixels 22. This is significant because it reduces computation time (e.g. because a program doesn't have to determine the color of an entire pixel 20 to change a single sub-pixel 22). Further, allowing the specific addressing of sub-pixels is an advantage over prior art because it can allow the programmer more flexibility in programming and/or the application program more direct control over the specific sub-pixels.

Further, in one preferred embodiment of the invention, the system 30 would allow the addressing of either the whole pixels 20 or individual sub-pixels 22. This embodiment would be particularly suitable if both old technology applications (e.g. those that do not take advantage of the present invention) and new technology applications were to be run on the system 30. Further, the addressing of either the whole pixels 20 or individual sub-pixels 22 is an advantage over prior art because the advantages of both systems could be used in a single system.

In another preferred embodiment, the present invention might allow the addressing of both whole pixels 20 and individual sub-pixels 22, the determination of which might be addressed being made on a periodic basis (e.g. pixel by pixel, sub-pixel by sub-pixel, or page by page) or by signals being sent to the system 30. This embodiment might be particularly suitable for simultaneously displaying a text image and a graphics image where a separate mode is used for each image type.

System:

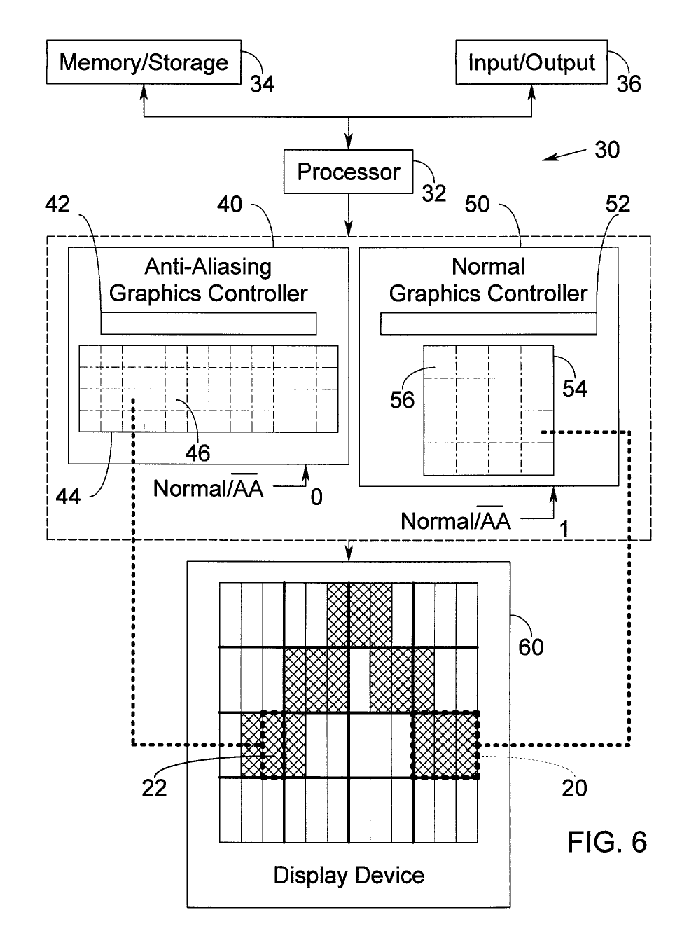

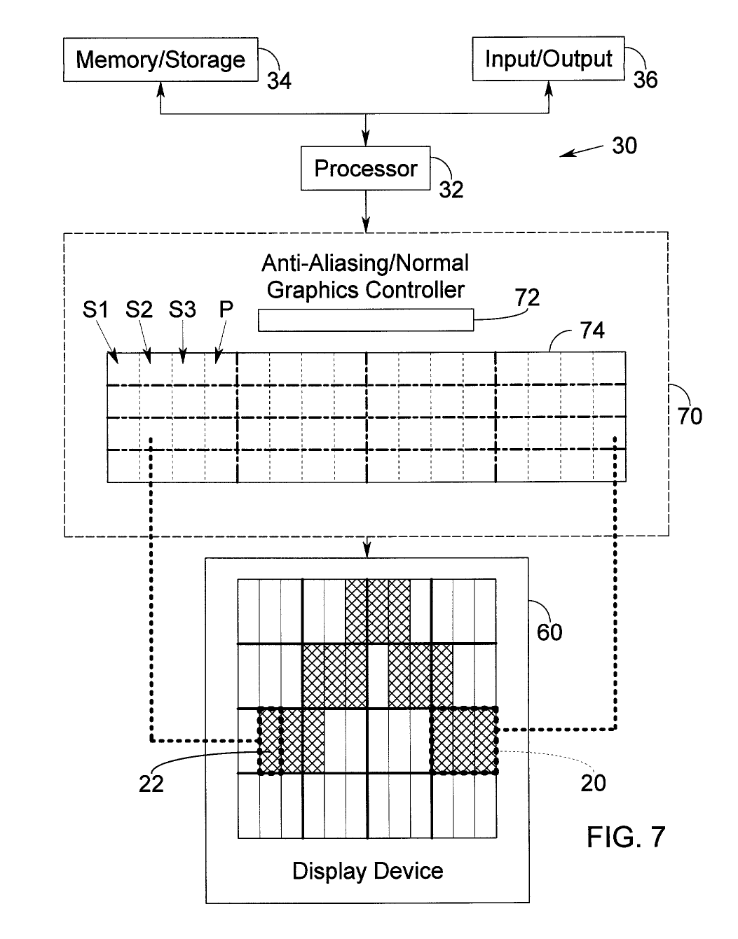

FIGS. 6 and 7 show an exemplary system 30 incorporating the present invention. The system 30 may be a network, a personal computer, a PDA, a specific utility device (e.g. a cell phone or an electronic game), electronic books (“e-books”), or any computing system. For simplicity, the shown system 30 shows only a single general processor 32 and dedicated processors 42, 52, and 72. There may, however, be any number of general or dedicated processors and the invention described herein may be implemented on general and/or dedicated processors. For simplicity, the shown system 30 shows only a single general memory/storage device 34 and dedicated memory/storage 44, 54, and 74. There may, however, be any number of general or dedicated memory/storage and the invention described herein may be implemented on general and/or dedicated memory/storage. The memory may be of one or more types including, but not limited to, read only memory (ROM), random access memory (RAM), hard disk, magnetic disk, (magneto) optical disk, magnetic cassettes, flash memory cards, digital video disks, Bernoulli cartridges, or any other form of memory or storage device. For simplicity, the shown system 30 shows only a single input/output device 36, but there may be multiple input/output 36 devices and dedicated input/output devices 36. The input/output device 36 may be of one or more types including, but not limited to, keyboard, pointing device (e.g. mouse), joystick, game pad, satellite dish, scanner, touch screen, or any other form of input/output device. Buses, interfaces (e.g. serial port, parallel port, game port, and universal serial bus), peripherals, dedicated controllers, and other system details have been simplified or eliminated as they would be known to those skilled in the art. As the present invention is particularly concerned with the graphics controller (described below), the specifics (and even the presence) of these features may be varied significantly without affecting the scope of the invention.

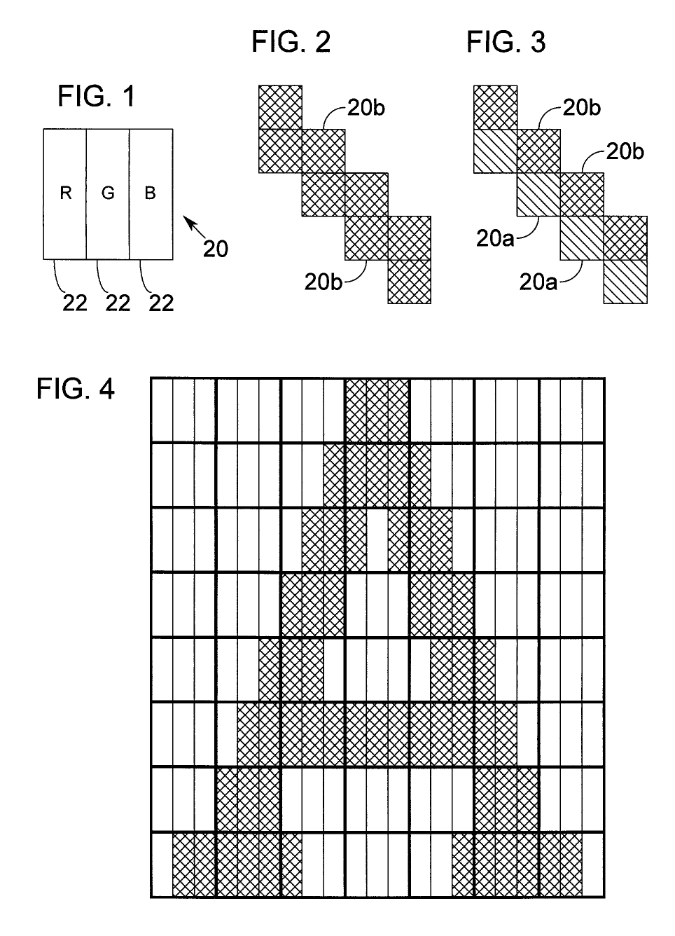

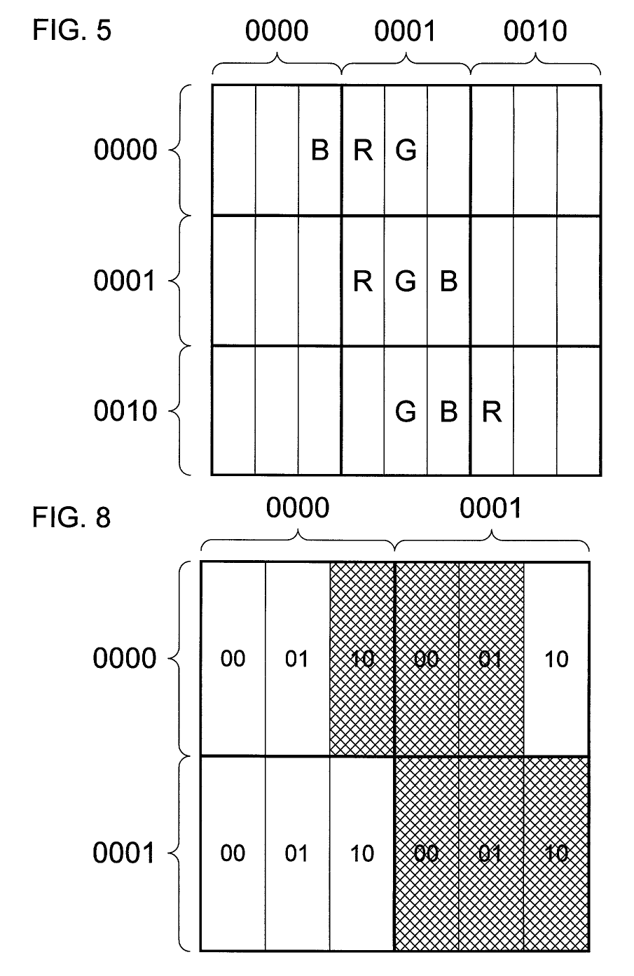

FIGS. 6 and 7 also show a display device 60. In the preferred embodiment, the display device 60 has an array of pixels 20 that may be selectively illuminated to display an image. In the shown display device 60, each pixel 20 is preferably comprised of three sub-pixels 22. If the display device 60 is a color display device, the three pixels may be assigned the three primary colors: red (R), blue (b), or green (G) as shown in FIG. 1.

FIG. 6 shows an exemplary preferred embodiment of the present invention in which the system 30 also includes an anti-aliasing graphics controller 40 and a normal graphics controller 50. The anti-aliasing graphics controller 40 may have an associated anti-aliasing graphics processor 42 and anti-aliasing graphics memory 44. The anti-aliasing graphics memory 44 may be divided into a plurality of sub-pixel memory locations 46, each sub-pixel memory location having a respective sub-pixel address associated therewith. Each sub-pixel memory location is preferably associated with a respective sub-pixel 22 on the display device 60. The normal graphics controller 50 may have an associated normal graphics processor 52 and normal graphics memory 54. The normal graphics memory 54 may be divided into a plurality of pixel memory locations 56, each pixel memory location having a respective pixel address associated therewith. Each pixel memory location is preferably associated with a respective pixel 20 on the display device 60.

FIG. 7 shows an exemplary alternative preferred embodiment of the system 30 in which the anti-aliasing graphics controller 40 and the normal graphics controller 50 are combined to form a single anti-aliasing/normal graphics controller 70. The shown anti-aliasing/normal graphics controller 70 may include an associated anti-aliasing/normal graphics processor 72 and an anti-aliasing/normal graphics memory 74 that is divided into a plurality of sub-pixel/pixel memory locations. In the shown embodiment, each pixel memory location is indexed by either a respective sub-pixel address (S1, S2, and S3) or a respective pixel address (P). Each sub-pixel address (S1, S2, and S3) is preferably associated with a respective sub-pixel 22 on the display device 60. Each pixel address (P) is preferably associated with a respective pixel 20 on the display device 60.

In another preferred embodiment the graphics controllers 40, 50 may be implemented as a single graphics controller having a single physical anti-aliasing/normal graphics processor but separate aliasing and normal graphics memories. In yet another additional preferred embodiment the graphics controllers 40, 50 may be implemented as a single graphics controller having separate aliasing and normal graphics processors but a single physical anti-aliasing/normal graphics memory. In other preferred embodiments the functions of the dedicated graphic controllers are implemented by the system processor 32. In still other preferred embodiments the functions of the dedicated graphic memories may be performed by the system memory 34. The present invention may also be implemented without a normal graphics controller 50, instead the anti-aliasing graphics controller 40 handling signals directed to a particular pixel as being sent to that pixel's grouping of sub-pixels. Finally, regardless of the physical structure of the graphic controller, the present invention may have a functional anti-aliasing graphics controller mode and a functional normal graphics controller mode.

Anti-Aliasing Mode:

The present invention contemplates the use of a system 30 that allows the specific addressing of sub-pixels 22. For exemplary purposes, this will be discussed as though the present invention is implemented without a normal graphics controller 50 and that the code is written for the anti-aliasing graphics controller 40. In this exemplary embodiment, if the anti-aliasing graphics controller 40 received standard “pixel code,” it might, for example, handle signals directed to a particular pixel as being sent to that pixel's grouping of sub-pixels. (Alternatively, if both graphic controllers 40, 50 were present, a signal at the beginning of the code or at appropriate places therein might designate the appropriate processing format.) As shown in FIG. 8, sub-pixels 22 may have specific addresses. In this embodiment, the row address is shown as four bits (allowing for 16 rows), the column address is shown as four bits (allowing for 16 columns), and the sub-pixel address is shown as two bits (although the shown embodiment uses only three sub-pixels). An additional four bits might be used to designate the luminance of the bit (e.g. 0000 being “off,” 1111 being “on,” and numbers between being gradations thereof. Accordingly, the example shown in FIG. 8 could be coded as follows:

### Example Code 1

Row 1:
00000000 00 0000
00000000 01 0000
00000000 10 1111
00000001 00 1111
00000001 01 1111
00000001 10 0000
Row 2:
00010000 00 0000
00010000 01 0000
00010000 10 0000
00010001 00 1111
00010001 01 1111
00010001 10 1111

An application program using a raster graphic system might take this information and store it as a pixmap (pixel map) in memory such as a graphics controller memory (e.g. frame buffer). Using the pixmap, the image might then be displayed on the display device 60.

Combined Mode:

The present invention also contemplates a system 30 that would allow the addressing of whole pixels 20, individual sub-pixels 22, or both whole pixels 20 and individual sub-pixels 22.

Using the anti-aliasing/normal graphics controller 70 of FIG. 7, this could be accomplished using a single anti-aliasing/normal memory 74. For exemplary purposes, this will be discussed as though each signal specifically designates whether it is directed to a whole pixel 20 or a sub-pixel 22. As was shown in FIG. 8, the row addresses may be designated with four bits (allowing for 16 rows). The four shown rows (top to bottom) might be designated “0000,” “0001,” “0010,” and “0001.” The column addresses may be designated with four bits (allowing for 16 columns). The four shown columns (left to right) might be designated “0000,” “0001,” “0010,” and “0001.” The next two bits might designate sub-pixel 1 (S1) as “00,” sub-pixel 2 (S2) as “01,” sub-pixel 3 (S3) as “10,” and the whole pixel (P) as “11.” There might be a rule that indicates that if the pixel (P) is specifically addressed it would override the individual sub-pixels. (Alternatively, the rule could be that if any sub-pixel is specifically addressed it would override the pixel (P).) An additional four bits might be used to designate the luminance of the pixel (e.g. 0000 being “off,” 1111 being “on,” and numbers between being gradations thereof). Accordingly, Row 2 and Row 3 of the example shown in FIG. 7 could be coded as follows:

### Example Code 2

| Row 2: | |
|---|---|
| 00010000 11 0000 | The entire first pixel is off. |
| 00010001 11 1111 | The entire second pixel is on. |
| 00010010 00 0000 | The first sub-pixel of the third pixel is off. |
| 00010010 01 1111 | The second sub-pixel of the third pixel is on. |
| 00010010 10 1111 | The third sub-pixel of the third pixel is on. |
| 00010011 00 1111 | The first sub-pixel of the fourth pixel is on. |
| 00010011 01 0000 | The second sub-pixel of the fourth pixel is off. |
| 00010011 10 0000 | The third sub-pixel of the fourth pixel is off. |
| Row 3: | |
| 00100000 00 0000 | The first sub-pixel of the first pixel is off. |
| 00100000 01 1111 | The second sub-pixel of the first pixel is on. |
| 00100000 10 1111 | The third sub-pixel of the first pixel is on. |
| 00100001 00 1111 | The first sub-pixel of the second pixel is on. |
| 00100001 01 0000 | The second sub-pixel of the second pixel is off. |
| 00100001 10 0000 | The third sub-pixel of the second pixel is off. |
| 00100010 11 0000 | The entire third pixel is off. |
| 00100011 11 1111 | The entire fourth pixel is on. |

An application program using a raster graphic system might take this information and store it as a pixmap (pixel map) in memory such as a graphics controller memory (e.g. frame buffer). Using the pixmap, the image might then be displayed on the display device 60.

The combined mode could also be implemented using the anti-aliasing graphics controller 40 and a normal graphics controller 50 of FIG. 6. For exemplary purposes, this will be discussed as though a mode signal Normal/\overline{A}\overline{A} is applied to control whether the anti-aliasing graphics controller 40 or the normal graphics controller 50 handle a particular signal. In this example, when the mode signal Normal/\overline{A}\overline{A} is low, the anti-aliasing graphics controller 40 handles the signal and when the mode signal Normal/\overline{A}\overline{A} is high the normal graphics controller 50 handles a particular signal. Again, the row addresses may be designated with four bits (allowing for 16 rows). The four shown rows (top to bottom) might be designated “0000,” “0001,” “0010,” and “0001.” The column addresses may be designated with four bits (allowing for 16 columns). The four shown columns (left to right) might be designated “0000,” “0001,” “0010,” and “0001.” If the signal is being processed in the anti-aliasing mode, there might be a signal that designates which sub-pixel is being addressed (sub-pixel (S1), sub-pixel 2 (S2), or sub-pixel 3 (S3).) and the luminance (for exemplary purposes, “on” and “off”). If the signal is being processed in the normal mode, there might be a signal that designates the color of the pixel (the sub-pixels may be illuminated to achieve the color). Accordingly, Row 2 and Row 3 of the example shown in FIG. 6 could be coded as follows in the anti-aliasing mode, the normal mode, and the combined mode:

### Anti-Aliasing Mode Example

| | | | |
|---|---|---|---|
| Normal/\overline{A}\overline{A} | Address | Sub-pixel | Luminance |

Row 2:

| | | | |
|---|---|---|---|
| 0 | 00010000 | S1 | off |
| 0 | 00010000 | S2 | off |
| 0 | 00010000 | S3 | off |
| 0 | 00010001 | S1 | on |
| 0 | 00010001 | S2 | on |
| 0 | 00010001 | S3 | on |
| 0 | 00010010 | S1 | off |
| 0 | 00010010 | S2 | on |
| 0 | 00010010 | S3 | on |
| 0 | 00010011 | S1 | on |
| 0 | 00010011 | S2 | off |
| 0 | 00010011 | S3 | off |

Row 3:

| 0 | 00100000 | S1 | off |
|---|---|---|---|
| 0 | 00100000 | S2 | on |
| 0 | 00100000 | S3 | on |
| 0 | 00100001 | S1 | on |
| 0 | 00100001 | S2 | off |
| 0 | 00100001 | S3 | off |
| 0 | 00100010 | S1 | off |
| 0 | 00100010 | S2 | off |
| 0 | 00100010 | S3 | off |
| 0 | 00100011 | S1 | on |
| 0 | 00100011 | S2 | on |
| 0 | 00100011 | S3 | on |
| Normal/\overline{A}\overline{A} | Address | Color | |

Normal Mode Example
Row 2:

| | | |
|---|---|---|
| 1 | 00010000 | white |
| 1 | 00010001 | black |
| 1 | 00010010 | green/blue |
| 1 | 00010011 | red |

Row 3:

| | | |
|---|---|---|
| 1 | 00100000 | green/blue |
| 1 | 00100001 | red |
| 1 | 00100010 | black |
| 1 | 00100011 | white |

| | | |
|---|---|---|
| Normal/\overline{A}\overline{A} | Address | Sub-pixel/Luminance or Color |

Combined Mode Example
Row 2:

| 1 | 00010000 | white | |
|---|---|---|---|
| 1 | 00010001 | black | |
| 0 | 00010010 | S1 | off |
| 0 | 00010010 | S2 | on |
| 0 | 00010010 | S3 | on |
| 0 | 00010011 | S1 | on |
| 0 | 00010011 | S2 | off |
| 0 | 00010011 | S3 | off |
| Normal/\overline{A}\overline{A} | Address | Sub-pixel | Luminance |

Row 3:

| | | | |
|---|---|---|---|
| 0 | 00100000 | S1 | off |
| 0 | 00100000 | S2 | on |
| 0 | 00100000 | S3 | on |
| 0 | 00100001 | S1 | on |
| 0 | 00100001 | S2 | off |
| 0 | 00100001 | S3 | off |
| 1 | 00100010 | black | |
| 1 | 00100011 | white | |

Alternative embodiments of the present invention could designate that the mode is always pixel by pixel (normal), always sub-pixel by sub-pixel (anti-aliasing), page by page, document by document, file by file, or other periodic basis.

Methods:

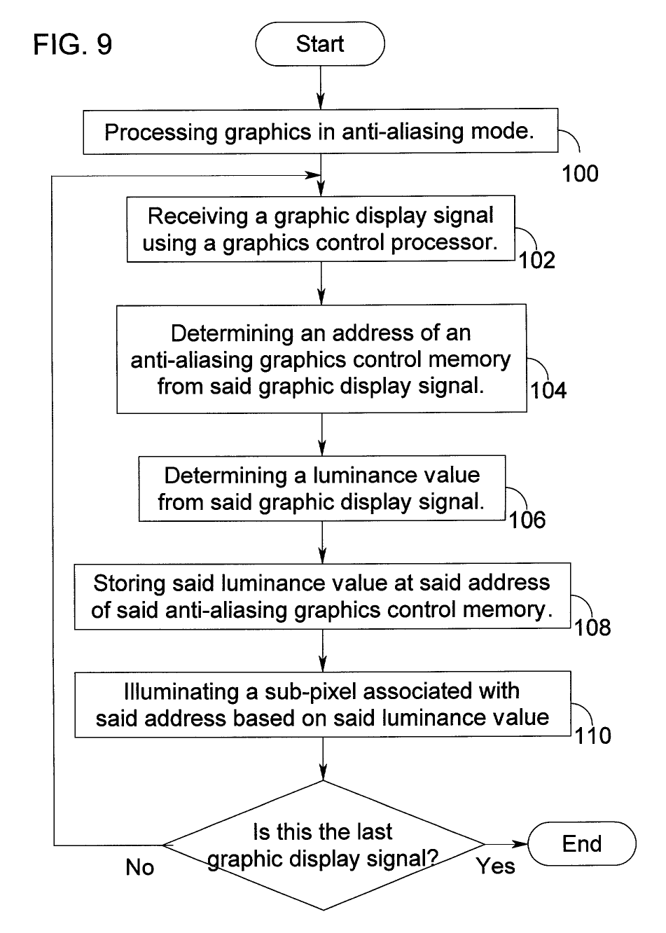

FIG. 9 shows an exemplary method for processing graphics in an anti-aliasing mode. More specifically, FIG. 9 shows an exemplary method for processing graphic display signals, each graphic display signal having an address associated with a sub-pixel on a display device 60 and a luminance value. First, the graphics control processor receives a graphic display signal 100. The graphics signal may be any signal capable of transmitting an address and a luminance value. Then, the graphics control processor determines an address of an anti-aliasing graphics control memory from the graphic display signal 104. The graphics control processor also determines a luminance value from the graphic display signal 106. The graphics control processor next stores the luminance value at the address of the anti-aliasing graphics control memory 108. Finally, the graphics control processor illuminates a sub-pixel associated with the address based on the luminance value 110. It should be noted that multiple luminance values may be stored before the sub-pixels are illuminated.

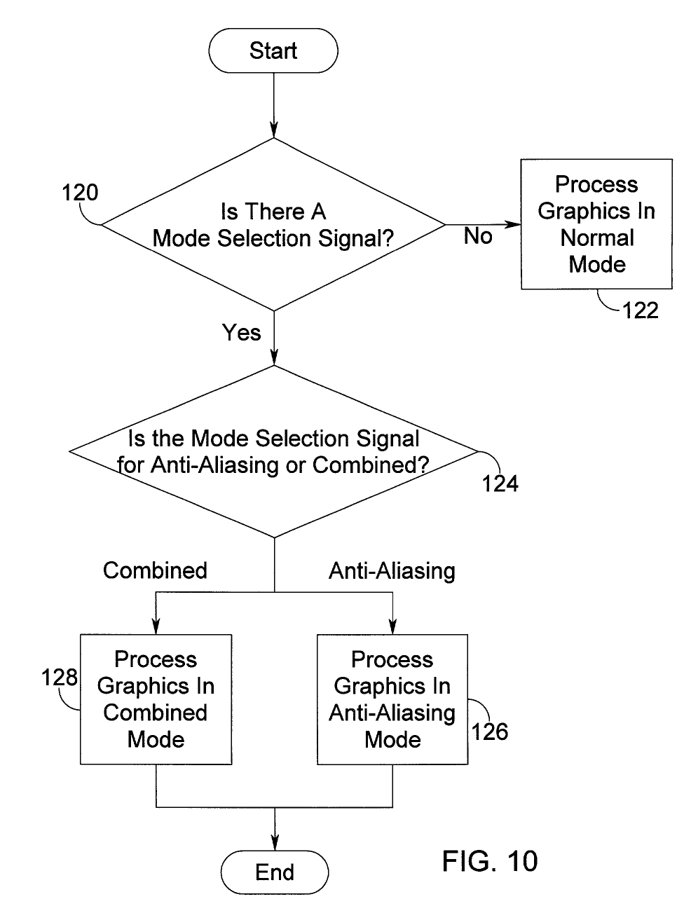

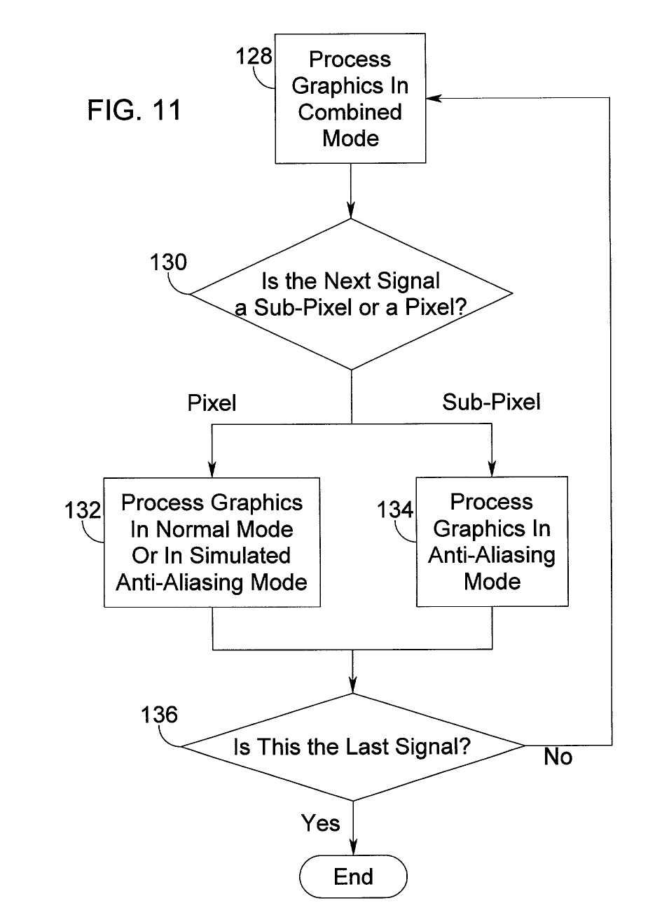

FIG. 10 is a flow chart showing an exemplary decision process for a system that allows for method for processing graphics in an anti-aliasing mode, a normal mode, and a combined mode. More specifically, the method of FIG. 10 is directed to a method for processing a graphic display signal having plurality of graphic display signal components (e.g. “words”) and displaying an image based on the graphic display signal on the display device 60. In this example, it is assumed that each of the plurality of graphic display signal components has an address and a luminance value. First, the graphics control processor receives a graphic display signal and determines if it is a mode selection signal 120. If no mode selection signal is present, the graphic display signal components may be processed in a normal mode 122. This might be the situation if the code was a preexisting code that was programmed without the benefit of the present invention. In relation to FIG. 6, all graphic display signal components might be passed to the normal graphics controller 50 and the display 60 might be controlled on a pixel by pixel basis. On the other hand, if the graphics control processor receives a mode selection signal, then the graphics control processor determines if the mode selection signal is an anti-aliasing selection signal or a combined selection signal 124. If the mode selection signal is an anti-aliasing selection signal the graphic display signal components may be processed in an anti-aliasing mode 126. On the other hand, if the mode selection signal is a combined selection signal the graphic display signal components may be processed in a combined mode 128 (FIG. 11). These steps may be repeated on a periodic basis such as pixel by pixel, sub-pixel by sub-pixel, or page by page.

FIG. 11 is a flow chart of an exemplary method for processing graphics in a combined mode including both an anti-aliasing mode and a normal mode. More specifically, FIG. 11 shows an exemplary embodiment of a method for processing the graphic display signal components in a combined mode. In this embodiment the graphic control signal components may address either pixels or sub-pixels 130. For example, in Example Code 2, two bits may be designate to designate whether the address and luminance values are for sub-pixel 1 (S1) 00, sub-pixel 2 (S2) 01, sub-pixel 3 (S3) as 10, or the whole pixel (P) 11. In this example, if the two bits are 01, 01, or 10, the processor would know that first graphic display signal component is addressing a sub-pixel. On the other hand, if the two bits are 11, the processor would know that first graphic display signal component is addressing a pixel. If the first graphic display signal component is addressing a sub-pixel, the first graphic display signal component is processed in the anti-aliasing mode 132. If the first graphic display signal component is addressing a pixel, the first graphic display signal component is processed in the normal mode 134. It should be noted that in the combined mode, if control was turned over to the anti-aliasing or normal modes, the steps therein most likely would not be repeated.

Examples herein are meant to be exemplary and are not meant to limit the scope of the invention. For example, many of the examples have been given specific addressing schemes that are meant to aid in the understanding of the invention, not to limit the scope of the invention. It should be noted that the present invention was described in primarily in terms of two-tone (e.g. black and white) displays. Specifics to the special considerations of color displays have been simplified as they would be handled in a similar manner as a black and white system, handled by software, or handled by a sub-system incorporated into or associated with the present system. Further, problems that exist with the use of color displays (e.g. color fringing and spatial displacement) could be solved in much the same manner as known correction schemes using the present invention using software or a subsystem incorporated into or associated with the present system. It should also be noted that the shown color displays are in the common RGB striping configuration. Alternative configurations (e.g. zig-zags and delta patterns) could be adapted to work with the present invention. Further, the present invention might be suitable for operations other than anti-aliasing such as image scaling, hinting, and other color processing operations.

Although the term “LCD” is used throughout the specification, the present invention could apply to other types of displays. For example, other flat panel displays such as Organic EL displays could also work using the concepts of the present invention. New technology such as electronic paper and higher resolution displays could also use the concepts discussed in this specification.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. An anti-aliasing system for use with at least one input/output device and at least one display device, said display device having a plurality of pixels, each pixel divided into a plurality of sub-pixels, said anti-aliasing system comprising:
(a) a first graphics controller;
(b) a first graphics processor functionally associated with said first graphics controller, said first graphics controller suitable for receiving signals from said at least one input/output device and for sending instructions to said display device;
(c) a first graphics memory functionally associated with said first graphics controller;
(d) a plurality of sub-pixel addresses stored in said first graphics memory, each of said plurality of sub-pixels having an associated sub-pixel address; and
(e) wherein signals provided to said first graphics controller control each of said plurality of sub-pixels using its associated sub-pixel address.

2. The anti-aliasing system of claim 1, further comprising:
(a) a second graphics controller;
(b) a second graphics processor functionally associated with said second graphics controller, said second graphics controller suitable for receiving signals from said at least one input/output device and for sending instructions to said display device; and
(c) a second graphics memory functionally associated with said second graphics controller;
(d) a plurality of pixel addresses stored in said second graphics memory, each of said plurality of pixels having an associated pixel address;
(e) wherein signals provided to said second graphics controller control each of said plurality of pixels using its associated pixel address.

3. The anti-aliasing system of claim 2, wherein said first graphics controller and said second graphics controller are a single graphics controller.

4. The anti-aliasing system of claim 2, wherein said first graphics memory and said second graphics memory are a single graphics memory.

5. A graphics controller for use with an external system, wherein said external system includes at least one display device, said display device having a plurality of pixels, each pixel divided into a plurality of sub-pixels, said graphics controller comprising:
(a) a processor suitable for receiving control signals and for sending instructions to said display device;
(b) memory functionally associated with said processor;
(c) a plurality of sub-pixel addresses stored in said memory, each of said plurality of sub-pixels having an associated sub-pixel address; and
(d) said processor having an anti-aliasing graphics control mode, each of said plurality of sub-pixels being addressed by its associated sub-pixel address in said anti-aliasing graphics control mode;
(e) wherein control signals provided to said processor actuate said anti-aliasing graphics control mode.

6. The graphics controller of claim 5, further comprising:
(a) a plurality of pixel addresses stored in said memory, each of said plurality of pixels having an associated pixel address; and
(b) said processor having a normal graphics control mode, each of said plurality of pixels being addressed by its associated pixel address in said normal graphics control mode;
(c) wherein control signals provided to said processor actuate said normal graphics control mode.

7. The graphics controller of claim 6, further comprising:
(a) said processor having an anti-aliasing graphics processor, said anti-aliasing graphics processor processing graphics when said processor is in said anti-aliasing graphics control mode; and
(b) said processor having a normal graphics processor, said normal graphics processor processing graphics when said processor is in said normal graphics control mode.

8. The graphics controller of claim 6, further comprising:
(a) said memory having an anti-aliasing graphics memory, said anti-aliasing graphics memory storing said plurality of sub-pixel addresses; and
(b) said memory having a normal graphics memory, said normal graphics memory storing said plurality of pixel addresses.

9. The graphics controller of claim 6 wherein said anti-aliasing graphics control mode and said normal graphics control mode may be performed simultaneously.

10. The graphics controller of claim 6 further comprising a combined mode in which signals may be used to select said between anti-aliasing graphics control mode and said normal graphics control mode.

11. A method for processing graphic display signals and displaying an image based on said graphic display signals on at least one display device, said display device having a plurality of pixels, each pixel divided into a plurality of sub-pixels, said method comprising the steps of:
(a) receiving a graphic display signal using a graphics control processor;
(b) determining an address of an anti-aliasing graphics control memory from said graphic display signal;
(c) determining a luminance value from said graphic display signal;
(d) storing said luminance value at said address of said anti-aliasing graphics control memory; and
(e) illuminating a sub-pixel associated with said address based on said luminance value.

12. The method of claim 11, further comprising the step of repeating steps (a)-(e) for each sub-pixel on said display.

13. A method for processing a graphic display signal having plurality of graphic display signal components and displaying an image based on said graphic display signal on at least one display device, each of said plurality of graphic display signal components having an address and a luminance value, said display device having a plurality of pixels, each pixel divided into a plurality of sub-pixels, said method comprising the steps of:
(a) receiving a graphic display signal using a graphics control processor;
(b) determining if there is a mode selection signal;
(c) processing said graphic display signal components in a normal mode if said mode selection signal is absent;
(d) determining if said mode selection signal is an anti-aliasing selection signal;
(e) processing said graphic display signal components in an anti-aliasing mode if said mode selection signal is an anti-aliasing selection signal;
(f) determining if said mode selection signal is a combined selection signal; and
(g) processing said graphic display signal components in a combined mode if said mode selection signal is a combined selection signal.

14. The method of claim 13, said step of processing said graphic display signal components in an anti-aliasing mode further comprising the steps of:
(a) determining an address of an anti-aliasing graphics control memory from a first graphic display signal component;
(b) determining a luminance value from said first graphic display signal component;
(c) storing said luminance value at said address of said anti-aliasing graphics control memory;
(d) illuminating a sub-pixel associated with said address based on said luminance value; and
(e) repeating steps (a)-(d) for each graphic display signal component.

15. The method of claim 13, said step of processing said graphic display signal components in a combined mode further comprising the steps of:
(a) determining if said first graphic display signal component is a sub-pixel;
(b) processing said first graphic display signal component in said anti-aliasing mode if said first graphic display signal component is a sub-pixel;
(c) determining if said first graphic display signal component is a pixel;
(d) processing said first graphic display signal component in said normal mode if said first graphic display signal component is a pixel; and
(e) repeating steps (a)-(d) for each graphic display signal component.

16. The method of claim 15, said step of processing said first graphic display signal component in said anti-aliasing mode further comprising the steps of:
(a) determining an address of an anti-aliasing graphics control memory from said first graphic display signal component;
(b) determining a luminance value from said first graphic display signal component;
(c) storing said luminance value at said address of said anti-aliasing graphics control memory; and
(d) illuminating a sub-pixel associated with said address based on said luminance value.

17. A system comprising:
(a) a display device, said display device having a plurality of pixels, each pixel divided into a plurality of sub-pixels;
(b) a processor suitable for receiving signals and for sending instructions to said display device, each signal having an mode actuating component, an address component, and a control component;
(c) memory functionally associated with said processor;
(d) a plurality of sub-pixel memory locations, each of said plurality of sub-pixels having an associated sub-pixel memory location, said address component of said signal suitable to index to a respective sub-pixel memory location, an associated control component being stored therein;
(e) a plurality of pixel memory locations, each of said plurality of pixels having an associated pixel memory location, said address component of said signal suitable to index to a respective pixel memory location, an associated control component being stored therein;
(f) said processor having an anti-aliasing graphics control mode, said mode actuating component being in a first state to actuate said anti-aliasing graphics control mode, each of said plurality of sub-pixels being controlled by the control component stored within the associated sub-pixel memory location;
(g) said processor having a normal graphics control mode, said mode actuating component being in a second state to actuate said normal graphics control mode, each of said plurality of pixels being controlled by the control component stored within the associated pixel memory location.

18. A graphics controller for use with an external system, wherein said external system includes at least one display device, said display device having a plurality of pixels, each pixel divided into a plurality of sub-pixels, said graphics controller comprising:
(a) processor means for receiving control signals and for sending instructions to said display device;
(b) memory means functionally associated with said processor;
(c) said memory means having a plurality of sub-pixel addressing means stored therein, each of said plurality of sub-pixels having an associated sub-pixel addressing means;
(d) said processor means having an anti-aliasing graphics control mode, each of said plurality of sub-pixels being addressed by its associated sub-pixel addressing means in said anti-aliasing graphics control mode; and
(e) means for providing control signals to said processor to actuate said anti-aliasing graphics control mode.

19. The graphics controller of claim 18, further comprising:
(a) said memory means having a plurality of pixel addressing means stored therein, each of said plurality of pixels having an associated pixel addressing means;
(b) said processor means having a normal graphics control mode, each of said plurality of pixels being addressed by its associated pixel addressing means in said normal graphics control mode; and
(c) means for providing control signals to said processor actuate said normal graphics control mode.

20. The graphics controller of claim 19, further comprising:
(a) said processor means having an anti-aliasing graphics processor means for processing graphics when said processor means is in said anti-aliasing graphics control mode; and
(b) said processor means having a normal graphics processor means for processing graphics when said processor means is in said normal graphics control mode.

21. The graphics controller of claim 19, further comprising:
(a) said memory means having an anti-aliasing graphics memory means for storing said plurality of sub-pixel addressing means; and
(b) said memory means having a normal graphics memory means for storing said plurality of pixel addressing means.

22. The graphics controller of claim 19 wherein said anti-aliasing graphics control mode and said normal graphics control mode may be performed simultaneously.

23. The graphics controller of claim 19 further comprising a combined mode in which signals may be used to select said between anti-aliasing graphics control mode and said normal graphics control mode.
